(19) United States
(12) Patent Application Publication
(10) Pub. No.: US 2023/0015313 A1
(43) Pub. Date: Jan. 19, 2023

(54) TRANSLATION METHOD, CLASSIFICATION MODEL TRAINING METHOD, DEVICE AND STORAGE MEDIUM

(71) Applicant: BEIJING BAIDU NETCOM SCIENCE TECHNOLOGY CO., LTD., Beijing (CN)

(72) Inventors: Chuanqiang Zhang, Beijing (CN); Ruiqing Zhang, Beijing (CN); Zhongjun He, Beijing (CN); Zhi Li, Beijing (CN); Hua Wu, Beijing (CN)

(73) Assignee: BEIJING BAIDU NETCOM SCIENCE TECHNOLOGY CO., LTD., Beijing (CN)

(21) Appl. No.: 17/656,160

(22) Filed: Mar. 23, 2022

(30) Foreign Application Priority Data
Jun. 30, 2021 (CN) 202110739519.1

(51) Int. Cl. G06F 40/58; G06F 40/279

(52) U.S. Cl. CPC G06F 40/58; G06F 40/279; G06F 40/51

(57) ABSTRACT

Disclosed are a translation method, a classification model training method, a device and a storage medium, which relate to the field of computer technologies, particularly to the field of artificial intelligence such as natural language processing and deep learning. The translation method includes: obtaining a current processing unit of a source language text based on a segmented word in the source language text; determining a classification result of the current processing unit with a classification model; and in response to determining that the classification result is the current processing unit being translatable separately, translating the current processing unit to obtain translation result in a target language corresponding to the current processing unit.

The present disclosure claims the priority and benefit of Chinese Patent Application No. 202110739519.1, filed on Jun. 30, 2021, entitled “TRANSLATION METHOD, CLASSIFICATION MODEL TRAINING METHOD AND APPARATUS, DEVICE AND STORAGE MEDIUM”. The disclosure of the above application is incorporated herein by reference in its entirety.

### TECHNICAL FIELD

The present disclosure relates to the field of computer technologies, particularly to the field of artificial intelligence such as natural language processing and deep learning, and more particular to a translation method, a classification model training method, a device and a storage medium.

### BACKGROUND

A simultaneous interpretation system generally includes an Auto Speech Recognition (ASR) system and a Machine Translation (MT) system. The ASR system is configured to perform speech recognition on source language speech to obtain a source language text corresponding to the source language speech. The MT system is configured to translate the source language text to obtain a target language text corresponding to the source language text.

In simultaneous interpretation or other similar scenarios, a problem of balance between translation quality and translation delay is required to be solved.

### SUMMARY

The present disclosure provides a translation method, a classification model training method, a device and a storage medium.

According to one aspect of the present disclosure, a translation method is provided, including: obtaining a current processing unit of a source language text based on a segmented word in the source language text; determining a classification result of the current processing unit with a classification model; and in response to determining that the classification result is the current processing unit being translatable separately, translating the current processing unit to obtain translation result in a target language corresponding to the current processing unit.

According to another aspect of the present disclosure, a classification model training method is provided, including: processing a segmented word in an original sample, to obtain at least one unit sample corresponding to the original sample; acquiring label information corresponding to each of the at least one unit sample, the label information being used for identifying whether the unit sample is translatable separately; constructing training data by using the unit samples and the label information corresponding to the unit sample; and training a classification model with the training data.

According to another aspect of the present disclosure, an electronic device is provided, including: at least one processor; and a memory in communication connection with the at least one processor; and the memory stores instructions executable by the at least one processor, and the instructions are executed by the at least one processor to enable the at least one processor to perform the method as described in any one of the above aspects.

According to another aspect of the present disclosure, a non-transitory computer-readable storage medium storing computer instructions is provided, and the computer instructions are configured to cause a computer to perform the method as described in any one of the above aspects.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF THE DRAWINGS

The accompanying drawings are intended to provide a better understanding of the solutions and do not constitute a limitation on the present disclosure. In the drawings,

FIG. 1 is a schematic diagram of a first embodiment according to the present disclosure;

FIG. 2 is a schematic diagram of a second embodiment according to the present disclosure;

FIG. 3 is a schematic diagram of a third embodiment according to the present disclosure;

FIG. 4 is a schematic diagram of a fourth embodiment according to the present disclosure;

FIG. 5 is a schematic diagram of a fifth embodiment according to the present disclosure;

FIG. 6 is a schematic diagram of a sixth embodiment according to the present disclosure;

FIG. 7 is a schematic diagram of a seventh embodiment according to the present disclosure;

FIG. 8 is a schematic diagram of an eighth embodiment according to the present disclosure;

FIG. 9 is a schematic diagram of a ninth embodiment according to the present disclosure; and

FIG. 10 is a schematic diagram of an electronic device configured to perform any one of a translation method and a classification model training method according to embodiments of the present disclosure.

### DETAILED DESCRIPTION OF EMBODIMENTS

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

For simultaneous interpretation, high translation quality and low translation delay are important requirements. Generally, if the translation model has more input information, the translation quality may be higher, but the translation delay may also be higher. Therefore, the problem of balance between the translation quality and the translation delay should be taken into account.

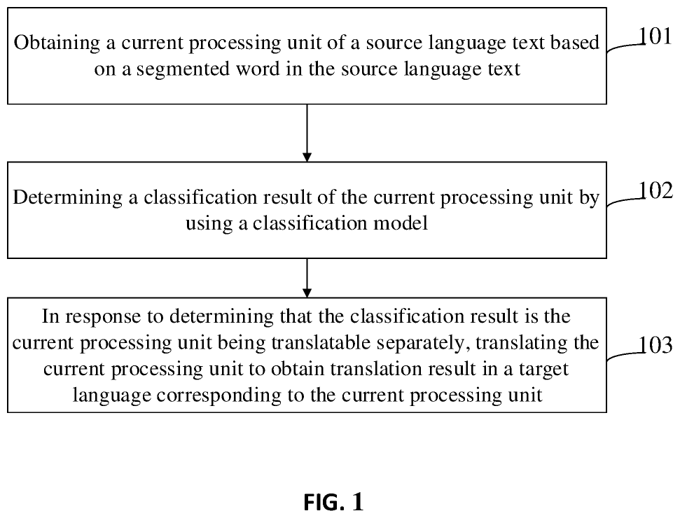

FIG. 1 is a schematic diagram of a first embodiment according to the present disclosure. This embodiment provides a translation method, including the following processes.

In 101, a current processing unit of a source language text is obtained based on a segmented word in the source language text.

In 102, a classification result of the current processing unit is determined with a classification model.

In 103, in response to determining that the classification result is the current processing unit being a meaningful unit (MU), the current processing unit is translated to obtain translation result in a target language corresponding to the current processing unit.

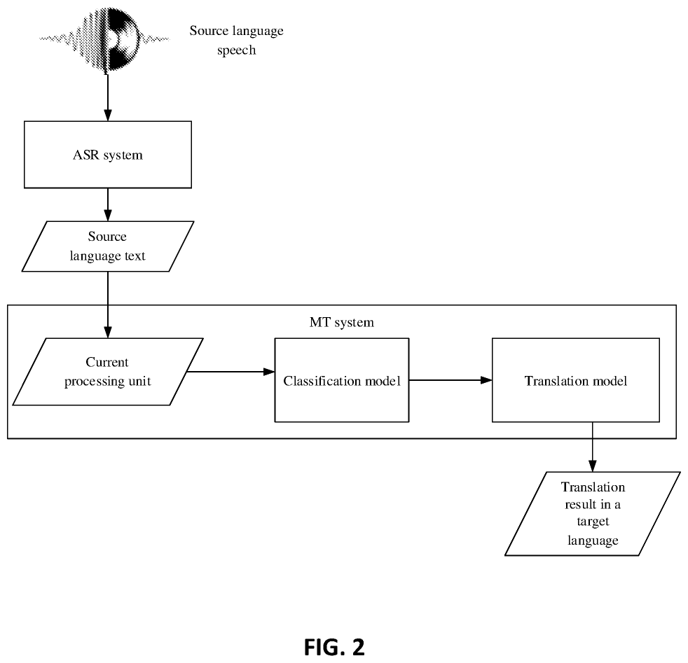

Taking simultaneous interpretation as an example, as shown in FIG. 2, a simultaneous interpretation system may include an ASR system and a MT system. The ASR system may perform speech recognition on source language speech to obtain a source language text corresponding to the source language speech. The MT system is configured to translate the source language text to obtain a target language text corresponding to the source language text. In an embodiment of the present disclosure, for example, the source language is Chinese and the target language is English.

The source language text may include at least one segmented word, which may be expressed as, for example, X={x1, x2 . . . , xT}, where X represents the source language text, xi(i=1, 2, . . . T) represents an i^{th} segmented word in the source language text, and T denotes a total number of segmented words in the source language text.

The source language text may obtain the at least one segmented word by word segmentation in various related arts. For example, if the source language text is “shang wu shi dian wo qu le tang gong yuan ( [symbol] )” after word segmentation, corresponding segmented words include “shang wu ( [symbol] ), shi (10) dian ( [symbol] ), wo ( [symbol] ), qu le ( [symbol] ), tang ( [symbol] ), gong yuan ( [symbol] )”. Different segmented words are separated by commas.

In order to ensure translation quality, the translation is generally performed in units of sentences. For example, assuming that “shang wu shi dian wo qu le tang gong yuan” in the above example is a sentence, the translation model is required to wait till the entire sentence “shang wu shi dian wo qu le tang gong yuan” to obtain a corresponding translation result, for example, “At 10 a.m I went to the park”. Such translation in units of sentences has a relatively high delay.

In order to reduce the delay, the translation may be performed in units of segmented words. For example, the translation may be started after a delay of a fixed number of segmented words. Based on the above example, for example, “shang wu shi” may be translated after the segmented word “shi” is received. However, this segmentation manner only considers a number of information, which may lead to poor translation quality.

In order to balance translation quality and translation delay, after the current processing unit is obtained, it may be judged whether the current processing unit is translatable separately, and if yes, the current processing unit is translated.

A unit “being translatable separately” may also mean that the unit is “a Meaningful unit (MU)”, which means a minimum unit with a translation result that may not be affected by subsequent input.

For example, in the above example, an initial translation result of “shang wu” is “morning”. With subsequent continuous input, for example, the input is updated to “shang wu, shi, dian”, and a corresponding translation result is updated to “At 10 a.m”. Since the translation result of “shang wu” may be affected by subsequent input, “shang wu” cannot be taken as an MU. In another example, an initial translation result of “ shang wu, shi, dian” is “At 10 a.m”. With subsequent continuous input, the input is updated to “shang wu, shi, dian, wo”, and a corresponding translation result is updated to “At 10 a.m, I”. For the unit “shang wu, shi, dian”, its translation result is not affected even if “wo” is subsequently inputted. Therefore, “shang wu, shi, dian” may be taken as an MU.

When the current processing unit is an MU, or is translatable separately, its translation result is not affected by subsequent input. Therefore, the translation quality may be ensured.

In this embodiment, the current processing unit is translated, and the current processing unit is obtained based on segmented words, so that translation may be performed based on the current processing unit instead of sentences, which may reduce translation delay. A classification result of the current processing unit is determined, so that the current processing unit is translated only when the current processing unit is translatable separately, which may ensure translation quality, thereby balancing the translation quality and the translation delay.

In some embodiments, at least one segmented word is provided, and obtaining a current processing unit of a source language text based on segmented words in the source language text includes: selecting one segmented word from the at least one segmented word in order as a current segmented word; forming a segmented word sequence according to all segmented word/words no later than the current segmented word; and taking a part not translatable separately in the segmented word sequence as the current processing unit of the source language text.

“In order” should be interpreted as in time sequence. For example, based on the above example, “shang wu” is selected as a current segmented word at a first moment, and “shi” is selected as a current segmented word at a second moment.

“No later than” in “no later than the current segmented word” should be interpreted as including the current segmented word. Taking the second moment as an example, a first segmented word sequence corresponding to the second moment is “shang wu, shi”.

Initial states of segmented words in the segmented word sequence are all non-separable parts. With the classification of the current processing unit, a part translatable separately may exist in the segmented word sequence, and then the segmented word sequence from which the part is removed is the current processing unit.

For example, at the first moment, the segmented word sequence is “shang wu”, which is a part not translatable separately. Therefore, “shang wu” is taken as the current processing unit of the first moment. It is assumed that it is determined upon classification by the classification model that “shang wu” is not translatable separately. That is, “shang wu” is a part not translatable separately. At the second moment, the segmented word sequence is “shang wu, shi” . “shang wu” is a part not translatable separately, and the initial state of “shi” is also a part not translatable separately. Therefore, “shang wu, shi” at the second moment is taken as the current processing unit. It is assumed that it is determined upon processing by the classification model that “shang wu, shi” is a part not translatable separately. Similarly, at a third moment, the segmented word sequence is “shang wu, shi, dian”. “shang wu, shi” is a part not translatable separately, and the initial state of “dian” is also a part not translatable separately. Therefore, “shang wu, shi, dian” at the third moment is taken as the current processing unit. It is assumed that it is determined upon processing by the classification model that “shang wu, shi, dian” is translatable separately. The segmented word sequence at next moment, that is, at a fourth moment, is “shang wu, shi, dian, wo”. “shang wu, shi, dian” is a part translatable separately and is required to be removed. Therefore, the current processing unit corresponding to the fourth moment is “wo”.

The current segmented word is selected in order and the current processing unit is obtained based on the current segmented word, so that the current processing unit may be classified and translated in order, which is in line with sequential execution of an actual translation scenario.

As shown in FIG. 2, after the current processing unit is obtained, the current processing unit may be classified by using a classification model, so as to obtain a classification result corresponding to the current processing unit.

The classification model is a binary classification model. Specifically, the classification result includes: the current processing unit being translatable separately, or the current processing unit being not translatable separately.

In some embodiments, the determining a classification result of the current processing unit by using a classification model includes: forming a reference sequence based on a preset number of segmented word/words following the current segmented word; and taking the segmented word sequence and the reference sequence as input of the classification model, and processing the input with the classification model, to determine the classification result of the current processing unit.

“Following” in “following the current segmented word” should be interpreted as not including the current segmented word. The preset number may be represented by m, which is a number of reference words. Taking m=2 as an example, assuming that the current segmented word is xt, the reference sequence may be expressed as: reference sequence={x(t+1) . . . , x(t+m)}. For a part where t+m is greater than T, null is selected.

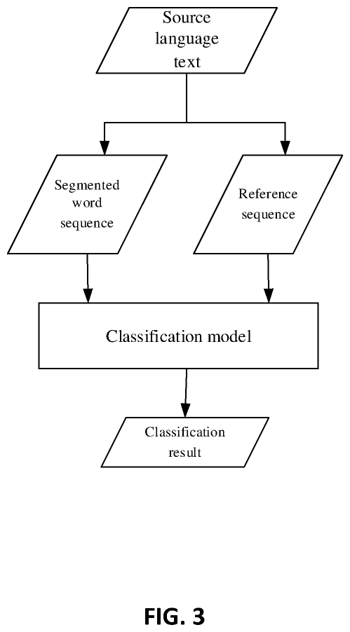

As shown in FIG. 3, for the source language text, a segmented word sequence and a reference sequence may be obtained based on the current segmented word, input of the classification model includes the segmented word sequence and the reference sequence, and output of the classification model is the classification result of the current processing unit. Since the input of the classification model includes the segmented word sequence, the output may also be considered as a classification result of the segmented word sequence.

The segmented word sequence and the reference sequence are taken as the input of the classification model, which may improve accuracy of the classification result.

If the current processing unit is an MU, the current translation unit may be simultaneously translated without the need to wait for subsequent input, and a translation result is outputted in a form of, for example, text or speech. For example, a translation text in a target language corresponding to the current processing unit is outputted to a display screen, or speech synthesis is performed on the translation text to obtain speech of the target language, and then the corresponding speech of the target language is played through an output apparatus such as a speaker.

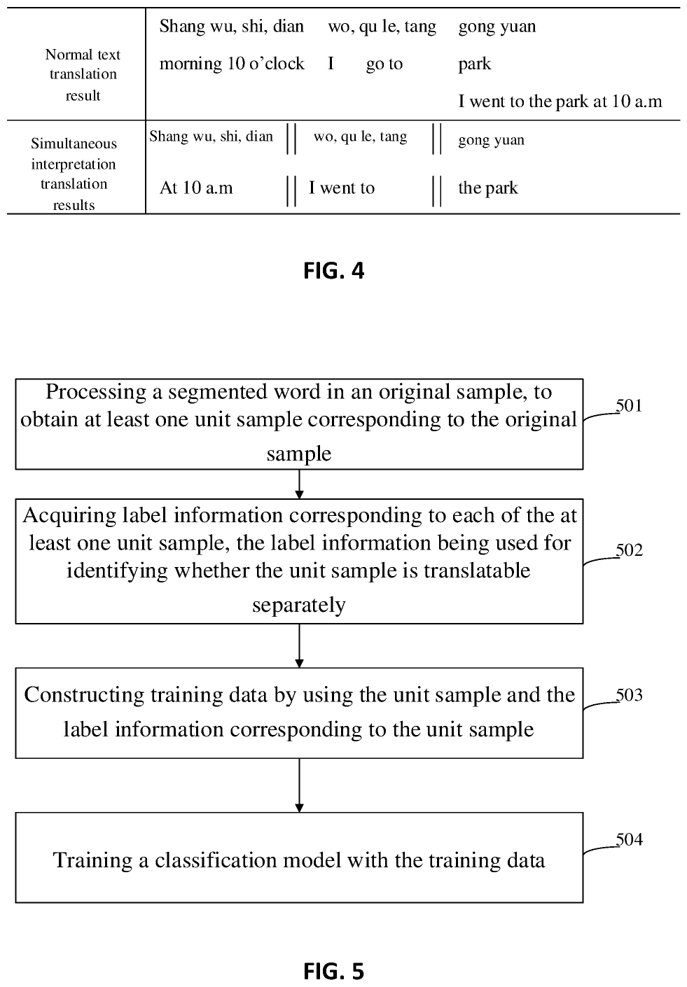

Based on the above example, it is assumed that three units translatable separately, that is, three MUs, are obtained, which are “shang wu, shi, dian”, “wo, qu le, tang ” and “gong yuan” respectively. As shown in FIG. 4, based on the MUs, translation results (represented by “simultaneous interpretation translation results”) of the MUs may be simultaneously acquired, and there is no need to wait for input of the entire sentence to obtain a translation result (represented by “normal text translation result”).

An application process is taken as an example in the above embodiment, which involves a classification model. That is, the classification model is used to judge whether a processing unit is an MU or translatable separately. The classification model is obtained by training prior to the application process. A training process of the classification model is described below.

FIG. 5 is a schematic diagram of a fourth embodiment according to the present disclosure. This embodiment provides a classification model training method, including the following processing.

In 501, an original sample is processed to obtain at least one unit sample corresponding to the original sample.

In 502, label information corresponding to each of the at least one unit sample is acquired, the label information being used for identifying whether the unit sample is translatable separately.

In 503, training data is constructed by using the unit sample and the label information corresponding to the unit sample.

In 504, a classification model is trained with the training data.

Still taking the sentence “shang wu shi dian wo qu le tang gong yuan” as an example, the sentence may be taken as an original sample during the training.

In some embodiments, the original sample includes at least one segmented word, and processing segmented words in an original sample to obtain at least one unit sample corresponding to the original sample includes: selecting one segmented word from the at least one segmented word in order as a current segmented word; and forming a unit sample according to all segmented word/words no later than the current segmented word.

Assuming that the original sample includes T segmented words, T unit samples may be obtained. Based on the above example, unit samples ct corresponding to different moments t may be shown in Table 1.

TABLE 1

| t | ct |
|---|---|
| 1 | shang wu |
| 2 | shang wu, shi |
| 3 | shang wu, shi, dian |
| 4 | shang wu, shi, dian, wo |
| 5 | shang wu, shi, dian, wo, qu le |
| 6 | shang wu, shi, dian, wo, qu le, tang |
| 7 | shang wu, shi, dian, wo, qu le, tang, gong yuan |

Further, a reference sample may also be obtained after the original sample is processed. The reference sample ft refers to a sequence formed by a preset number (such as m=2) of segmented words following the current segmented word.

Then, training data may be constructed based on a triple <unit sample, reference sample, label information>.

Assuming that the label information is represented by lt, lt=1 indicates that the unit sample is translatable separately, and lt=0 indicates that the unit sample is not translatable separately, the training data may be shown in Table 2.

TABLE 2

| t | ct | ft | lt |
|---|---|---|---|
| 1 | shang wu | shi, dian | 0 |
| 2 | shang wu, shi | dian, wo | 0 |
| 3 | shang wu, shi, dian | wo, qu le | 1 |
| 4 | shang wu, shi, dian, wo | qu le, tang | 0 |
| 5 | shang wu, shi, dian, wo, qu le | tang, gong yuan | 0 |
| 6 | shang wu, shi, dian, wo, qu le, tang | gong yuan | 1 |
| 7 | shang wu, shi, dian, wo, qu le, tang, | NULL | 1 |
| | gong yuan | | |

The unit sample is formed based on the current segmented word, so that a plurality of unit samples may be generated based on one original sample, thereby expanding a number of the unit samples.

In some embodiments, the original sample is a source language text, and acquiring label information corresponding to each of the at least one unit sample includes: acquiring an entire-sentence translation result in a target language corresponding to the source language text; translating each of the at least one unit sample to obtain a unit translation result in the target language corresponding to each of the at least one unit sample; and in response to determining that at least part of content of the unit translation result and the entire-sentence translation result is identical and at correspondingly consistent positions, determinining the label information as information identifying that the unit sample is an MU.

“At least part of content of the unit translation result and the entire-sentence translation result is identical and at correspondingly consistent positions” may mean that the unit translation result is a prefix of the entire-sentence translation result.

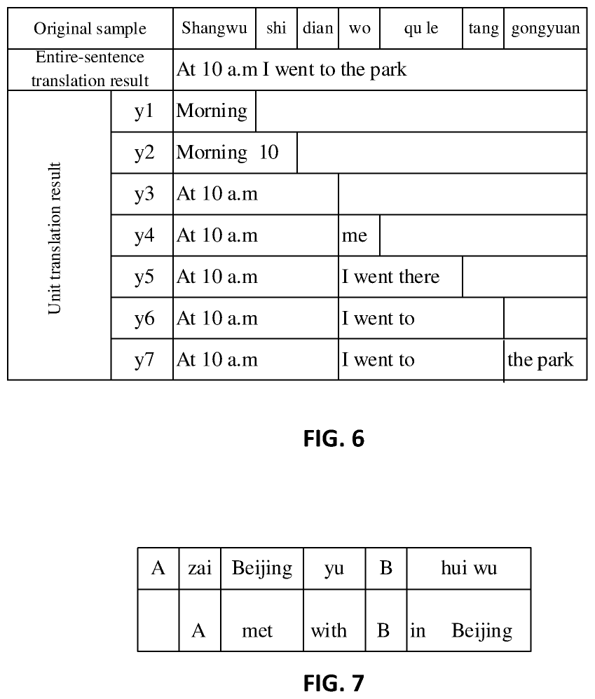

Assuming that the unit translation result corresponding to the unit sample at different moments t is represented by yt, the source language text, the entire-sentence translation result and the unit translation result may be shown in FIG. 6. Referring to FIG. 6, since the unit translation result of “shang wu, shi, dian” is “At 10 a.m” and the unit translation result is the prefix of the entire-sentence translation result, label information corresponding to “shang wu, shi, dian” is lt=1. Similarly, since the unit translation result of “shang wu, shi, dian, wo, qu le, tang” is “At 10 a.m I went to” and the unit translation result is the prefix of the entire-sentence translation result, label information corresponding to “shang wu, shi, dian, wo, qu le, tang” is lt=1.

It is determined, based on whether the unit translation result is the prefix of the entire-sentence translation result, whether the corresponding unit sample is translatable separately, which can ensure semantic integrity of the unit translatable separately and improve the quality of translation.

When the unit translation result of each unit sample is obtained, if a normal translation manner is adopted, that is, the translation model is used for translation by taking each unit sample as input of the translation model, each unit sample may not be translated separately, and only the entire sentence of the original sample is translatable separately. In this way, the classification model trained by the above training data can only recognize long MUs, resulting in an excessively long translation delay.

For example, the original sample is “A, zai ( [symbol] ), Beijing( [symbol] ), yu( [symbol] ), B, hui wu( [symbol] [symbol] )”, in the normal translation manner, label information corresponding to the entire sentence “A, zai, Beijing, yu, B, hui wu” is generally set to 1, and label information of the remaining unit samples is set to 0.

The unit sample with label information 1 is excessively long, which leads to an excessively long translation delay of the classification model trained by the unit sample in application.

In order to reduce the translation delay, the length of the unit sample as the MU may be reduced as much as possible.

In some embodiments, the original sample includes a segmented word, and translating the unit samples to obtain a unit translation result in the target language corresponding to the unit samples includes: taking each of the ate least one unit sample and a preset number of segmented word/words following the unit sample as input of a translation model, and translating the input with the translation model, to obtain the unit translation result in the target language corresponding to each of the at least one unit sample.

The corresponding “a preset number” in translation herein is not correlated with the preset number in the reference sample or the reference sequence. That is, the corresponding preset number in translation may be represented by k, which is different from m in the reference sample or the reference sequence, and k represents a delay of k segmented words before translation. Such a translation manner may be referred to as wait-k translation.

The wait-k translation manner has predictive ability and can generate correct translation results without waiting for the complete input of the entire sentence. For example, taking “A, zai, Beijing, yu, B, hui wu” as an example, when k=2, a corresponding translation result is as shown in FIG. 7. That is, after the segmented word “Beijing” is received, the translation result may be predicted as “met”, without the need to wait for the receipt of the segmented word “hui wu” and translate it as “met”.

Based on the wait-k translation manner, in simultaneous interpretation, it may be learned that 6 units “A”, “zai”, “Beijing”, “yu”, “B” and “hui wu” are translatable separately, instead of the unit of the entire sentence “A, zai, Beijing, yu, B, hui wu” being translatable separately. Then, each unit translatable separately may be translated simultaneously, thereby reducing the translation delay.

When the unit translation result of the unit sample is obtained, translation is performed by wait-k, so that a unit sample translatable separately with a smaller length may be obtained, and then a unit translatable separately with a shorter length can be recognized based on the classification model trained by the training data constructed by the unit sample, thereby reducing the translation delay.

In this embodiment, the training data of the classification model is constructed through the original sample, so that an amount of training data can be expanded. The label information is used for identifying whether the unit sample is translatable separately, the classification model that can recognize whether a unit is translatable separately may be trained, and then the unit translatable separately may be translated, thereby balancing the translation quality and the translation delay.

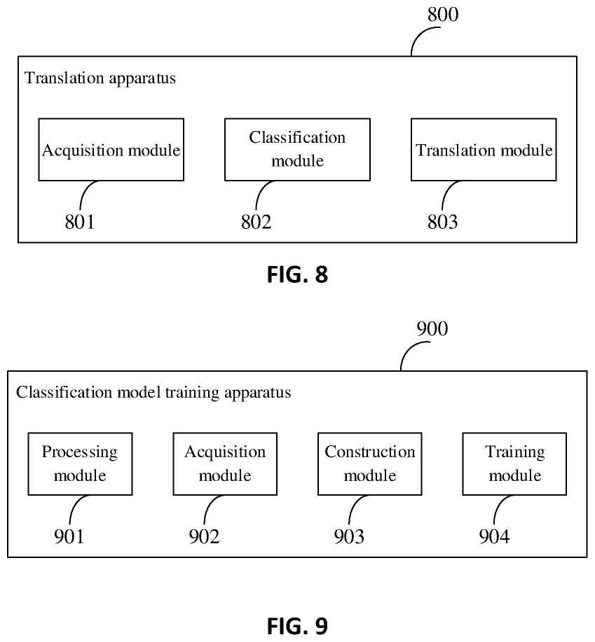

FIG. 8 is a schematic diagram of an eighth embodiment according to the present disclosure. This embodiment provides a translation apparatus. As shown in FIG. 8, the translation apparatus 800 includes: an acquisition module 801, a classification module 802 and a translation module 803.

The acquisition module 801 is configured to obtain a current processing unit of a source language text based on a segmented word in the source language text. The classification module 802 is configured to determine a classification result of the current processing unit with a classification model. The translation module 803 is configured to, in response to determining that the classification result is the current processing unit being translatable separately, translate the current processing unit to obtain translation result in a target language corresponding to the current processing unit.

In some embodiments, at least one segmented word is provided, and the acquisition module 801 is specifically configured to: select one segmented word from the at least one segmented word in order as a current segmented word; forming a segmented word sequence according to all segmented word/words no later than the current segmented word; and take a part not translatable separately in the segmented word sequence as the current processing unit of the source language text.

In some embodiments, the classification module 802 is specifically configured to: form a reference sequence based on a preset number of segmented word/words following the current segmented word; and take the segmented word sequence and the reference sequence as input of the classification model, and process the input with the classification model, to determine the classification result of the current processing unit.

In this embodiment, the current processing unit is translated, and the current processing unit is obtained based on segmented words, so that translation may be performed based on the current processing unit instead of sentences, which may reduce translation delay. A classification result of the current processing unit is determined, so that the current processing unit is translated only when the current processing unit is translatable separately, which may ensure translation quality, thereby balancing the translation quality and the translation delay.

FIG. 9 is a schematic diagram of a ninth embodiment according to the present disclosure. This embodiment provides a classification model training apparatus. As shown in FIG. 9, the classification model training apparatus 900 includes: a processing module 901, an acquisition module 902, a construction module 903 and a training module 904.

The processing module 901 is configured to process a segmented word in an original sample, to obtain at least one unit sample corresponding to the original sample. The acquisition module 902 is configured to acquire label information corresponding to each of the at least one unit sample, the label information being used for identifying whether the unit sample is translatable separately. The construction module 903 is configured to construct training data by using the unit sample and the label information corresponding to the unit sample. The training module 904 is configured to train a classification model with the training data.

In some embodiments, the original sample includes at least one segmented word, and the processing module 901 is specifically configured to: select one segmented word from the at least one segmented word in order as a current segmented word; and form a unit sample according to all segmented word/words no later than the current segmented word.

In some embodiments, the original sample is a source language text, and the acquisition module 902 is specifically configured to: acquire an entire-sentence translation result in a target language corresponding to the source language text; translate each of the at least one unit sample to obtain a unit translation result in the target language corresponding to each of the at least one unit sample; and in response to determining that at least part of content of the unit translation result and the entire-sentence translation result is identical and at correspondingly consistent positions, determine the label information as information identifying that the unit sample is an MU.

In some embodiments, the acquisition module 902 is specifically configured to: take each of the at least one unit sample and a preset number of segmented word/words following the unit samples as input of a translation model, and translate the input with the translation model, to obtain the unit translation result in the target language corresponding to each of the at least one unit sample.

In this embodiment, the training data of the classification model is constructed through the original sample, so that an amount of training data can be expanded. The label information is used for identifying whether the unit sample is translatable separately, the classification model that can recognize whether a unit is translatable separately may be trained, and then the unit translatable separately may be translated, thereby balancing the translation quality and the translation delay.

It may be understood that the same or similar contents in different embodiments may be referred to each other in the embodiments of the present disclosure.

It may be understood that “first”, “second” and the like in the embodiments of the present disclosure are intended only for differentiation, and do not indicate a degree of importance or sequence.

According to embodiments of the present disclosure, the present disclosure further provides an electronic device, a readable storage medium and a computer program product.

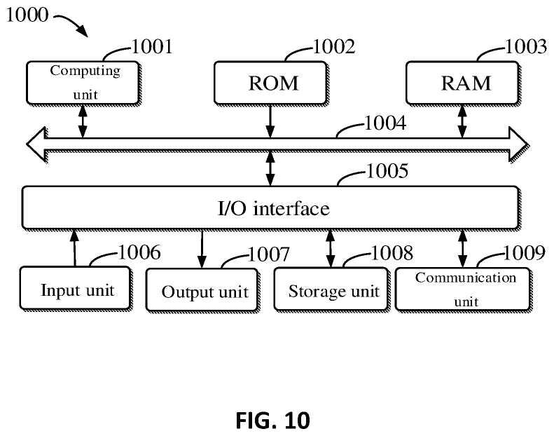

FIG. 10 is a schematic block diagram of an exemplary electronic device 1000 that can be configured to implement embodiments of the present disclosure. The electronic device is intended to represent various forms of digital computers, such as laptops, desktops, workbenches, personal digital assistants, servers, blade servers, mainframe computers and other suitable computers. The electronic device may further represent various forms of mobile devices, such as personal digital assistants, cellular phones, smart phones, wearable devices and other similar computing devices. The components, their connections and relationships, and their functions shown herein are examples only, and are not intended to limit the implementation of the present disclosure as described and/or required herein.

As shown in FIG. 10, the electronic device 1000 includes a computing unit 1001, which may perform various suitable actions and processing according to a computer program stored in a read-only memory (ROM) 1002 or a computer program loaded from a storage unit 10010 into a random access memory (RAM) 1003. The RAM 1003 may also store various programs and data required to operate the electronic device 1000. The computing unit 1001, the ROM 1002 and the RAM 1003 are connected to one another by a bus 1004. An input/output (I/O) interface 1005 may also be connected to the bus 1004.

A plurality of components in the electronic device 1000 are connected to the I/O interface 1005, including an input unit 1006, such as a keyboard and a mouse; an output unit 1007, such as various displays and speakers; a storage unit 1008, such as disks and discs; and a communication unit 1009, such as a network card, a modem and a wireless communication transceiver. The communication unit 1009 allows the electronic device 1000 to exchange information/data with other devices over computer networks such as the Internet and/or various telecommunications networks.

The computing unit 1001 may be a variety of general-purpose and/or special-purpose processing components with processing and computing capabilities. Some examples of the computing unit 1001 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 1001 performs the methods and processing described above, such as the operator registration method for a deep learning framework. For example, in some embodiments, the translation method or the classification model training method may be implemented as a computer software program that is tangibly embodied in a machine-readable medium, such as the storage unit 1008. In some embodiments, part or all of a computer program may be loaded and/or installed on the electronic device 1000 via the ROM 1002 and/or the communication unit 1009. One or more steps of the operator registration method for a deep learning framework described above may be performed when the computer program is loaded into the RAM 1003 and executed by the computing unit 1001. Alternatively, in other embodiments, the computing unit 1001 may be configured to perform the methods described in the present disclosure by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a load programmable logic device (CPLD), computer hardware, firmware, software, and/or combinations thereof. Such implementations may include implementation in one or more computer programs that are executable and/or interpretable on a programmable system including at least one programmable processor, which can be special or general purpose, coupled to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, a random access memory (RAM), a read-only memory (ROM), an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, voice input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN) and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, also known as a cloud computing server or cloud host, which is a host product in the cloud computing service system to solve the problems of difficult management and weak business scalability in the traditional physical host and a virtual private server (VPS). The server may also be a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the extent of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the extent of protection of the present disclosure.

What is claimed is:

1. A translation method, comprising:
obtaining a current processing unit of a source language text based on a segmented word in the source language text;
determining a classification result of the current processing unit with a classification model; and
in response to determining that the classification result is the current processing unit being translatable separately, translating the current processing unit to obtain translation result in a target language corresponding to the current processing unit.

2. The method according to claim 1, wherein the segmented word comprises at least one segmented word, and wherein obtaining the current processing unit of the source language text based on the segmented word in the source language text comprises:
selecting one segmented word from the at least one segmented word in order as a current segmented word;
forming a segmented word sequence according to all segmented word/words no later than the current segmented word; and
taking a part not translatable separately in the segmented word sequence as the current processing unit of the source language text.

3. The method according to claim 2, wherein determining the classification result of the current processing unit by using the classification model comprises:
forming a reference sequence based on a preset number of segmented word/words following the current segmented word; and
taking the segmented word sequence and the reference sequence as input of the classification model, and processing the input with the classification model, to determine the classification result of the current processing unit.

4. A classification model training method, comprising:
processing a segmented word in an original sample, to obtain at least one unit sample corresponding to the original sample;
acquiring label information corresponding to each of the at least one unit sample, the label information being used for identifying whether the unit sample is translatable separately;
constructing training data by using the unit sample and the label information corresponding to the unit sample; and
training a classification model with the training data.

5. The method according to claim 4, wherein the original sample comprises at least one segmented word, and wherein processing the segmented word in the original sample, to obtain the at least one unit sample corresponding to the original sample comprises:
selecting one segmented word from the at least one segmented word in order as a current segmented word; and
forming a unit sample according to all segmented word/words no later than the current segmented word.

6. The method according to claim 4, wherein the original sample is a source language text, and wherein acquiring the label information corresponding to each of the at least one unit sample comprises:
acquiring an entire-sentence translation result in a target language corresponding to the source language text;
translating each of the at least one unit sample to obtain a unit translation result in the target language corresponding to each of the at least one unit sample; and
in response to determining that at least part of content of the unit translation result and the entire-sentence translation result is identical and at correspondingly consistent positions, determining the label information as information identifying that the unit sample is a meaningful unit.

7. The method according to claim 6, wherein translating each of the at least one unit sample to obtain a unit translation result in the target language corresponding to each of the at least one unit sample comprises:
taking each of the at least one unit sample and a preset number of segmented word/words following the unit sample as input of a translation model, and translating the input with the translation model, to obtain the unit translation result in the target language corresponding to each of the at least one unit sample.

8. An electronic device, comprising:
at least one processor; and
a memory in communication connection with the at least one processor; wherein
the memory stores instructions executable by the at least one processor, and the instructions are executed by the at least one processor to enable the at least one processor to perform the method according to claim 1.

9. The electronic device according to claim 8, wherein the segmented word comprises at least one segmented word, and wherein obtaining the current processing unit of the source language text based on the segmented word in the source language text comprises:
selecting one segmented word from the at least one segmented word in order as a current segmented word;
forming a segmented word sequence according to all segmented word/words no later than the current segmented word; and
taking a part not translatable separately in the segmented word sequence as the current processing unit of the source language text.

10. The electronic device according to claim 9, wherein determining the classification result of the current processing unit by using the classification model comprises:
forming a reference sequence based on a preset number of segmented word/words following the current segmented word; and
taking the segmented word sequence and the reference sequence as input of the classification model, and processing the input with the classification model, to determine the classification result of the current processing unit.

11. An electronic device, comprising:
at least one processor; and
a memory in communication connection with the at least one processor; wherein
the memory stores instructions executable by the at least one processor, and the instructions are executed by the at least one processor to enable the at least one processor to perform the method according to claim 4.

12. The electronic device according to claim 11, wherein the original sample comprises at least one segmented word, and wherein processing the segmented word in the original sample, to obtain the at least one unit sample corresponding to the original sample comprises:
selecting one segmented word from the at least one segmented word in order as a current segmented word; and
forming a unit sample according to all segmented word/words no later than the current segmented word.

13. The electronic device according to claim 11, wherein the original sample is a source language text, and wherein acquiring the label information corresponding to each of the at least one unit sample comprises:
acquiring an entire-sentence translation result in a target language corresponding to the source language text;
translating each of the at least one unit sample to obtain a unit translation result in the target language corresponding to each of the at least one unit sample; and
in response to determining that at least part of content of the unit translation result and the entire-sentence translation result is identical and at correspondingly consistent positions, determining the label information as information identifying that the unit sample is a meaningful unit.

14. The electronic device according to claim 13, wherein translating each of the at least one unit sample to obtain a unit translation result in the target language corresponding to each of the at least one unit sample comprises:
taking each of the at least one unit sample and a preset number of segmented word/words following the unit sample as input of a translation model, and translating the input with the translation model, to obtain the unit translation result in the target language corresponding to each of the at least one unit sample.

15. A non-transitory computer-readable storage medium storing computer instructions, wherein the computer instructions are configured to cause a computer to perform the method according to claim 1.

16. The non-transitory computer-readable storage medium according to claim 15, wherein the segmented word comprises at least one segmented word, and wherein obtaining the current processing unit of the source language text based on the segmented word in the source language text comprises:
selecting one segmented word from the at least one segmented word in order as a current segmented word;
forming a segmented word sequence according to all segmented word/words no later than the current segmented word; and
taking a part not translatable separately in the segmented word sequence as the current processing unit of the source language text.

17. The non-transitory computer-readable storage medium according to claim 16, wherein determining the classification result of the current processing unit by using the classification model comprises:
forming a reference sequence based on a preset number of segmented word/words following the current segmented word; and
taking the segmented word sequence and the reference sequence as input of the classification model, and processing the input with the classification model, to determine the classification result of the current processing unit.

18. A non-transitory computer-readable storage medium storing computer instructions, wherein the computer instructions are configured to cause a computer to perform the method according to claim 4.

19. The non-transitory computer-readable storage medium according to claim 18, wherein the original sample comprises at least one segmented word, and wherein processing the segmented word in the original sample, to obtain the at least one unit sample corresponding to the original sample comprises:
selecting one segmented word from the at least one segmented word in order as a current segmented word; and
forming a unit sample according to all segmented word/words no later than the current segmented word.

20. The non-transitory computer-readable storage medium according to claim 18, wherein the original sample is a source language text, and wherein acquiring the label information corresponding to each of the at least one unit sample comprises:
acquiring an entire-sentence translation result in a target language corresponding to the source language text;
translating each of the at least one unit sample to obtain a unit translation result in the target language corresponding to each of the at least one unit sample; and
in response to determining that at least part of content of the unit translation result and the entire-sentence translation result is identical and at correspondingly consistent positions, determining the label information as information identifying that the unit sample is a meaningful unit.
